(19) United States
(12) Patent Application Publication
(10) Pub. No.: US 2013/0119894 A1
(43) Pub. Date: May 16, 2013

(54) Multiple DALI streams over single DALI interface on a wireless communication protocol personal area network

(71) Applicant: Verified Energy, LLC, Rochester, NY (US)

(72) Inventors: Thomas I. Yeh, Rochester, NY (US); David W. Sheehan, Glenville, NY (US)

(73) Assignee: VERIFIED ENERGY, LLC, Rochester, NY (US)

(21) Appl. No.: 13/666,261

(22) Filed: Nov. 1, 2012

Related U.S. Application Data
(60) Provisional application No. 61/554,320, filed on Nov. 1, 2011.

(51) Int. Cl. H05B 37/02

(52) U.S. Cl. CPC H05B 37/02
USPC 315/294

(57) ABSTRACT

Present invention is a system for which multiple DALI streams could be addressed over one DALI interface on a single wireless communication protocol (e.g., ZigBee) personal area network (PAN). Allowing multiple DALI streams to be controlled over a single ZigBee PAN reduces complexity, costs, and allows for more efficient utilization of bandwidth greatly increasing effective DALI bandwidth supported by a single wireless gateway. This enables multiple physical DALI Controllers to be attached, and also allows DALI Controllers which are unable to support the special DALI stream selection command to communicate with multiple streams on a single ZigBee PAN. Due to the diverse nature of DALI Controllers and control devices, having an interoperable approach is critical. This system allows for a baseline set of capabilities with DALI devices that do not support the additional reserved DALI commands and a set of advanced capabilities for devices that do.

This non-provisional patent application is being filed by Thomas I. Yeh of Rochester, N.Y. and David W. Sheehan of Glenville, N.Y.

### CROSS-REFERENCE TO RELATED PATENT APPLICATIONS

Priority for this patent application is based upon provisional patent application 61,554,320 (filed on Nov. 1, 2011). The disclosure of this United States patent application is hereby incorporated by reference into this specification.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provide for by the terms of DOE Cooperative Agreement DE-EE0003971 CFDA No. 81.086 awarded by the Department of Energy.

### TECHNICAL FIELD

The current invention relates to lighting control systems for homes, offices, commercial spaces, and public areas; more particularly to incorporating wireless networks into the lighting control systems; more particularly to lighting control systems using digitally addressable lighting interface (DALI) command protocol.

### BACKGROUND OF THE INVENTION

Centrally controlled lighting systems for homes, offices, commercial spaces, and public areas are well known in the art. One such control system is known as digital addressable lighting interface (DALI). DALI is a digital protocol for lighting control devices. DALI's two-wire physical network is a data bus connecting up to 64 DALI lighting control devices, such as ballasts, occupancy sensors, photo sensors and switch panels, to one DALI controller via physical and electrical connections termed as “ports”. Ports are physical and electrical connections for the DALI Controller and control devices to inter-connect. The DALI controller may be a central computer or other intelligent control unit.

Standards for DALI protocol such as National Electronics Manufacturers Association LSD 53-2010 in the United States and DALI Manual by ZVEI-Division Luminaires of Frankfurt Germany are well known in the Art.

In a wired implementation, a single DALI two-wire physical network is referred to as a “stream.” A stream may contain just a single DALI control device or as many as 64 DALI control devices, in addition to the stream's DALI Controller. Each DALI stream is limited to one DALI Controller serving as the Bus Master initiating all DALI commands. Each of the DALI control devices is assigned a unique address.

In FIG. 1 a simplified typical wired implementation of a DALI control system 100 is depicted. As those skilled in the art are aware, a DALI stream is defined as at least one DALI controller 110 and at least one controlled device 210 interconnected by a bus 120 made of two wires. To improve the noise immunity of the bus 120 the two wires are frequently deployed as a twisted pair.

DALI controllers and controlled devices may be connected as a star or (more commonly) may be daisy chained. The DALI specification provides for up to 64 controlled devices (ballasts, switches, sensors, etc.) to be connected to a common twisted pair bus. The bus 120 also requires a DC voltage, which may be physically provided as a standalone power supply 130 or the power supply function may be integrated into the physical package of a DALI controller or controlled device. Only one power supply is allowed.

Consequently, a DALI stream is one or more DALI controllers connected to a common twisted pair bus with up to 64 DALI controlled devices. The stream is energized by a DC voltage provided by a standalone power supply or by a DALI device connected to the stream.

One DALI controller 110 with a DALI port is connected to one DALI stream consisting of at least a single DALI controlled device 210 via a wired data bus 120. A DALI controlled device 210 is typically a DALI controllable ballast in a DALI controllable network but as those skilled in the art are aware, the DALI specification (NEMA LSD 53-2010) includes additional controlled device types, such as switch device, slide dimmer, motion (occupancy) sensor, scheduler, gateways, to name a few. The DALI specification also allows for multiple DALI controllers initiating DALI commands (both commands requiring no response and commands (also known as query commands or queries) requiring a response from the controlled devices) to the controlled devices connected on the same stream as the controllers. The terms “query” and “query command” as used herein are interchangeable and refer to a command that receives data from a controlled device either through a response containing data received from the controlled device or through the absence of a response in the case of certain queries.

In a wired implementation, a single stream and a DALI port has a one to one correspondence. One DALI port is also physically a single DALI stream formed by the two communications wires emanating and connecting all the DALI controlled devices on the stream. A ballast may be wired to a lamp 220 or a bank of lamps.

DALI protocol by specification is designed to transmit data at 1,200 cycles per second (Hertz (Hz)), plus or minus 10 percent. The time duration of each cycle is nominally equal to 833.33 microseconds.

A DALI forward frame is defined as a command transmitted from the DALI controller and contains an address byte and one or two data bytes.

A 2-bytes DALI forward frame, consisting of one address byte and a data byte, has 19-bits of data. A 3-bytes DALI forward frame, consisting of one address byte and two data bytes, has 27-bits of data.

A DALI back frame, defined as a reply responding to the immediate forward frame, consists of 11-bits of data.

DALI protocol employs Manchester encoding for serial data transmission. Manchester encoding requires two sampling intervals to decode a single data bit. DALI protocol refers to each sampling interval as “TE”. The duration of each TE is one half of 833.33 microseconds.

Standards for DALI protocol such as NEMA LSD 53-2010 in the United States and DALI Manual by ZVEI-Division Luminaires of Frankfurt Germany have identified reserved elements of the protocol for future expansion and for manufacturer specific extensions. A reserved element or a manufacturing specific extension element of the DALI protocol may be used as a special command within the current DALI specification. The original DALI specification based on 2-byte commands only supports reserved commands, which in theory should not be used for manufacturer extensions, although it is rather common for manufacturers to use reserved commands for their specific extensions. In the more current DALI specification such as the NEMA document the element of manufacturer specific commands are explicitly identified separately from the reserved commands.

In a DALI control system, the DALI controller 110 is frequently sending commands and queries to the DALI controlled devices 210 to ensure optimal operation of the DALI controlled devices 210. The DALI specification maintains a 22 TE maximum limit for each DALI controlled device 210 to respond to the DALI controller 110 for DALI commands requiring a response. This maximum limit of 9.16667 milliseconds is encoded into the protocol and is required of each DALI controlled device 210 when responding to the DALI controller 110.

There are many reasons why implementation using a wireless network would be desired, including simplifying building renovation and reduced installation expense by elimination of problematic communication wiring (i.e. long run communication wiring). A significant shortcoming of wireless network based implementations (e.g. implementing ZigBee protocol) is that the communications between devices cannot be guaranteed to occur within the DALI specification's maximum response time. The timing requirements of the DALI protocol are designed for a communication media where a DALI controller and the connected DALI stream is hardwired in a fashion that the delays or latency introduced by the media are near zero. This makes DALI incompatible with wireless communication media, where latency is non-deterministic and varies greatly depending on real-time network conditions, and can exceed the timing requirements of the DALI protocol. This is problematic for DALI configuration and special commands where the commands must be repeated within a specified timeframe as received by the DALI controlled device on the connected stream or it will be ignored. For DALI query commands, the protocol specifies a very short timing requirement for the responding DALI back frame (e.g. “data”) such that it is unreliable for most wireless networking schemes, especially a wireless network with low to moderate data rate such as ZigBee Alliance's IEEE 802 based high level communication protocols standard for personal area networks (PANs), to maintain compatibility with the DALI protocol. A DALI controlled device must begin transmitting a response to a DALI controller within 22 TE (about 9.17 ms). Any processing overhead to encode/decode a wireless signal (which is non-zero) the wireless transmission itself makes adherence to this difficult. With a protocol like ZigBee, it is typical to take at least 10-15 ms per communication hop through the network, which breaks this 22 TE response transmission initiation requirement immediately. As those skilled in the art are aware, in Zigbee a communication transmission may be relayed through multiple devices; each transmission between devices is referred to as a hop. Each communication transmission is termed a cluster; each ZigBee cluster, defined by a 16-bit identifier, contains both a command and at least one attribute where each command causes an action and each attribute tracks the current state of an element of the cluster (e.g., a level control cluster command can tell a ballast to adjust the intensity of a light and an attribute tracks the intensity of the light).

Without implementing a caching approach it will be costly, complicated and difficult to guarantee compliance with the DALI specification's maximum 22 TE limit for the DALI controlled device to response to the DALI controller. DALI commands that do not require a response from the DALI controlled device (e.g. unidirectional commands) do not require any accommodations on a controller-side wireless module functioning as an encapsulation gateway. In order to transparently encapsulate the DALI protocol, the encapsulation gateway attached to the DALI controller (controller-side encapsulation gateway) must cache data for all commands that the DALI controller could dispatch.

When the DALI protocol is encapsulated inside a wireless networking scheme, such as ZigBee, the physical wires limiting one DALI physical port to a single DALI stream are removed. Without the one to one correspondence of a DALI port to a DALI stream, one DALI Controller could address multiple DALI streams over wireless connections. This would be especially beneficial for a system where many DALI streams are sparsely populated as they could be aggregated and controlled by one DALI physical port.

Unfortunately, the DALI protocol lacks provision to allow multiple streams to be addressed over a single DALI port. Consequently, the full benefits of using wireless connections, removing the physical limitation of the DALI network wires, could not be fully realized.

Typical DALI deployments partition the light fixtures in a building on many separate DALI streams for reasons relating to bandwidth, maximum number of supported ballasts on a single stream, and the physical wiring and layout of the building. Most DALI controllers have multiple physical DALI interfaces that allow more than a single stream to be connected to the controller.

A single ZigBee PAN is capable of supporting hundreds of devices and provides sufficient bandwidth to support multiple DALI streams. Having a mechanism to support multiple streams on a single ZigBee PAN would simplify deployment, reduce cost, and more optimally utilizes constrained system resources.

A method to allow a wireless network to use the DALI protocol is to dedicate a ZigBee Personal Area Network (PAN) to a single physical DALI stream. This approach unnecessarily increases the number of separate wireless networks required, increasing complexity and costs, and increases potential of radio frequency interference between adjacent wireless PANs.

The present invention solves the problem of not being able to allow multiple streams to be addressed over a single DALI port and is an advancement beyond the current state of the art. The present invention is a system for supporting multiple logical DALI streams over a single DALI physical port with mechanism to support multiple logical DALI streams on a single ZigBee PAN.

Allowing multiple DALI streams to be controlled over a single ZigBee PAN reduces complexity, costs and allows for more efficient utilization of network resources. Additionally, multiple physical DALI ports communicating over a single ZigBee PAN greatly increase effective DALI bandwidth supported by a single wireless gateway, enabling multiple physical DALI Controllers to be attached to a single ZigBee PAN, and also allows legacy DALI Controllers who do not support the present invention's special DALI stream selection command mechanism to communicate with multiple streams on a single ZigBee PAN. The wireless gateway of the present invention is comprised of a controller-side wireless module and at least one ballast-side wireless module.

Due to the diverse nature of DALI Controllers and control devices, having an interoperable approach is critical. The present invention allows for a baseline set of capabilities with DALI controllers that do not support the additional special DALI commands and a set of advanced capabilities for DALI controllers that do.

In addition to supporting multiple DALI streams over a single wireless network, in some cases being able to support multiple DALI streams over a single physical DALI connection is desired. The present invention would allow a single interconnect between a wireless module and a DALI controller to support multiple DALI streams.

The claimed invention is an advancement over the current state of the art. Typical DALI deployments partition the light fixtures, input devices and sensors in a building on many separate DALI streams to allocate bandwidth, deploy maximum number of supported DALI devices on a single stream, and meet the limitations of installing physical wiring due to the layout of the building. Most DALI Controllers have multiple physical DALI interfaces that allow more than a single stream to be connected to the Controller. Each DALI stream is physically two wires that must be connected between the DALI Controller port and all the DALI devices on the stream. The current approach is to partition one DALI PAN to a DALI stream with one Controller Wireless Gateway. This approach increases the number of DALI Controllers and Controller Wireless Gateways which elevates costs and complexity.

Additionally, the bandwidth of each ZigBee PAN may be inefficiently utilized. This is because one PAN may support very few control devices while another ZigBee PAN may have to support many control devices. The PAN with few control devices could have unused bandwidth while the PAN with many control devices may have its bandwidth fully consumed, which could increase wireless communication latency. It would be beneficial to partition the DALI control devices over the two PANs in such a way where bandwidth of both PANs are optimally used.

The DALI Controllers may also be inefficiently utilized since one DALI Controller may support very few control devices while another DALI Controller may have to support many control devices. The one DALI Controller with few control devices could have excess of its 1200 HZ data Bus bandwidth available while the DALI Controller with many control devices could experience delays due to insufficient bandwidth on its 1200 HZ Data Bus.

### SUMMARY OF THE INVENTION

The present invention allows multiple DALI streams and multiple DALI Controllers to be wirelessly networked, such as over a single ZigBee PAN, which reduces complexity, costs, and allows for more efficient utilization of bandwidth. Additionally, multiple physical DALI ports may communicate over a single ZigBee PAN greatly increasing effective DALI bandwidth supported by a single wireless gateway, enabling multiple physical DALI Controllers to be attached, and also allowing legacy DALI Controllers who do not support the present invention's reserved DALI stream selection command mechanism to communicate with multiple streams on a single ZigBee PAN.

Moreover, the present invention implements an interoperable approach to accommodate the widely varying capabilities of DALI Controllers and control devices. This system allows for a baseline collection of capabilities with DALI Controllers that do not support the additional reserved DALI commands and a set of advanced capabilities for Controllers that do.

The present invention can also be deployed beyond lighting control to other building systems, such as Heating, Air Conditioning and Ventilation systems.

### BRIEF DESCRIPTION OF FIGURES

Embodiments of the present invention will be described by reference to the following drawings, in which like numerals refer to like elements, and in which:

FIG. 1 depicts a hard wired lighting system using a DALI interface;

FIG. 2 depicts an exemplary wireless lighting system with a single DALI controller controlling multiple streams;

FIG. 3 depicts an exemplary wireless lighting system with multiple DALI controllers controlling multiple streams;

FIG. 4 depicts an exemplary wireless lighting system with multiple DALI controllers controlling a single streams; and

FIGS. 5-7 each depict a comparison between hard wired lighting systems using a DALI interface and exemplary wireless lighting systems using DALI controls;

FIG. 8 depicts a flow chart for a method to control multiple DALI streams over single DALI interface on a ZigBee personal area network.

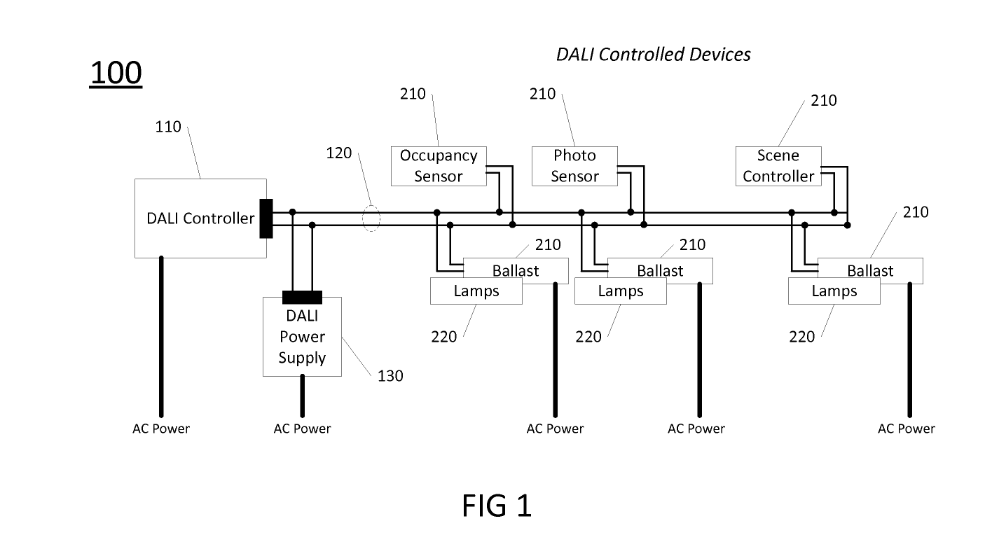

### DETAILED DESCRIPTION OF THE INVENTION

The present invention relates to the control of multiple DALI streams over a single DALI interface on a wireless communication protocol (e.g. ZigBee) personal area network.

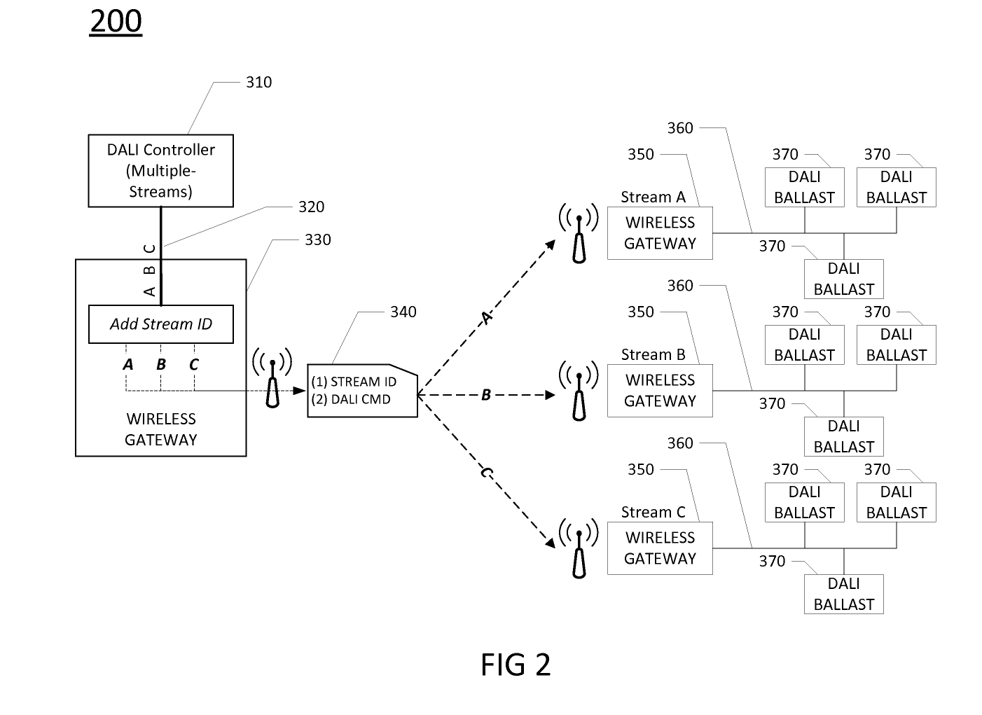

In FIG. 2 a preferred embodiment of an exemplary lighting control system 200 is depicted. A DALI controller 310 is connected via a first two wire data bus 320 (e.g. a twisted pair wire) to a controller-side wireless module 330. The controller-side wireless module 330 communicates via a wireless communication protocol to up to 64 ballast-side wireless modules 350. In this specification, the term wireless gateway may refer to at least one controller-side wireless module 330 or at least one ballast-side wireless module 350. For ease of narrative the wireless communication protocol in this representative example will be the ZigBee communication protocol. Other wireless communication protocols may be utilized. Each ballast-side wireless module 350 is connected via a second two wire data bus 360 to at least one DALI stream comprising at least one DALI ballast 370 (slave) which is connected to at least one lamp bank 380 (not depicted). To simplify the description, the term “ballast” will refer to any “peripheral device” that may be used in a DALI stream and the two terms may be used interchangeably along with the term “controlled device”. As those skilled in the art are well aware these peripheral devices may include, but are not limited to, ballasts, sensors, dimmer switches, timers, and the like. A DC power supply, not shown, may be integrated with the DALI Controller 310 or may be provided separately to the DALI controller 310. A separate DC power supply, also not shown, may be integrated with each ballast-side wireless module 350 or may be provided separately to each. Yeh and Sheehan disclose a method to encapsulate DALI commands in wireless networks in a patent cooperation treaty application (PCT/US/12/48340) which is hereby incorporated by reference in its entirety. The controller-side wireless module 330 and the ballast-side wireless module 350 each comprise a set of software components that encode and decode the DALI protocol and handle data encapsulation over an intermediate wireless medium while maintaining a reference to the DALI stream the traffic originated from and is destined to arrive and which provide for the seamless control of each lamp bank 380 by the DALI controller 310 even though the DALI controller 310 is not hard wired directly to DALI ballasts 370. It should be obvious to those skilled in the art that in other embodiments of the present invention that the DALI controller 310 may be wired directly to additional ballasts provided the DALI controller 310 does not perceive more than 64 ballasts on a single stream and also that the presence of DALI streams hardwired to a DALI controller does not preclude the novelty of the present invention.

Referring again to FIG. 2 and the preferred embodiment therein, the DALI controller 310 initially initiates a special DALI command and transmits the command to the controller-side wireless module 330. The special DALI command is a DALI command provides a stream identifier (ID) to the wireless gateway to indicate the appropriate DALI stream that shall be used for subsequent DALI commands that are sent. The special DALI command is completely allowed by DALI protocol.

The controller-side wireless module 330 translates the stream number specified by the DALI controller 310 to a stream ID parameter that is used to route the message within the wireless network. As an example of the use of a stream ID, in the embodiment of the present invention shown in FIG. 2, the three separate DALI streams are identified as Stream A, Stream B, and Stream C respectively. Each of these three DALI streams is provided a corresponding stream ID such as A, B, and C respectively. After sending the special stream ID command, the DALI controller then sends to the controller-side wireless module 330 DALI commands intended to control the ballasts 370 on the specified logical DALI stream. The controller-side wireless module 330 encapsulates the DALI commands within the wireless messages with the logical DALI stream ID.

In the remainder of the application the term special command is used for a controller to specify a logical stream ID. It is understood that the special command can be implemented using a reserved command or a manufacturer specific extension command, without deviating from novelty of the invention.

The controller-side wireless module 330 comprises at least one physical DALI port to establish a ZigBee PAN. The controller-side wireless module 330 receives a special DALI command from the DALI controller 310 indicating the logical DALI stream that shall be used for subsequent DALI commands that are sent. The controller-side wireless module 330 creates at least one wireless communication message packet 340 to be transmitted to the appropriate DALI stream from the special DALI command and the subsequent DALI command. The controller-side wireless module 330 also comprises firmware which embeds Stream ID with the wireless communication message packet 340.

The DALI logical stream identifier is embedded in the wireless communication message packet 340 that allows for proper routing to remote ballast-side wireless modules 350 attached to ballasts 350. Each ballast-side wireless module 350 physically constitutes a DALI stream with a unique stream ID (e.g., stream A, stream B, and stream C). A command meant for a ballast on stream A will receive a stream ID identifying that the ballast is on stream A; and likewise, a command meant for a ballast on stream B will receive a stream ID identifying that that ballast is on stream B. Each ballast-side wireless module 350 is configured with firmware to extract the stream ID from the wireless communication message packet 340 and will only process wireless communication message packets 340 with the corresponding matching stream ID delivered from the controller-side wireless module 310. The ballast-side wireless modules 350 are configured with their unique stream ID and therefore only process messages destined to themselves and their associated DALI stream.

When processing the wireless communication message packets 340 each ballast-side wireless module 350 will process the wireless communication message packets 340, and will further process the communication package 340 into a complete DALI command and pass the DALI command to ballasts 370 on its connected DALI stream according to the DALI protocol if the communication message packets 340 has the Stream ID matching the stream ID of the ballast-side wireless module.

The appropriate ballast 370 or ballasts 370 respond appropriately to the DALI command. The response is transmitted back to the DALI controller 310 by reversing the communication process.

The DALI controller 310 identifies the appropriate DALI stream to receive a DALI command by issuing the special DALI command of the appropriate logical DALI stream. By using this special DALI command, the DALI controller 310 can remotely address via wireless communication protocol numerous DALI peripherals and the DALI controller 310 is no longer limited to the physical limitation of 64 DALI ballasts per stream.

Multiple Controller DALI Implementation

It may be desirable to use multiple DALI controllers with a single wireless gateway. For example, if a DALI controller does not support the special DALI commands, (i.e., when the DALI controller is an older legacy controller) a logical DALI stream may be physically associated to a ballast-side wireless module to the port on which the DALI Controller is connected on the controller side wireless module. The DALI controller is capable of addressing up to 64 DALI ballasts but it is not capable of controlling multiple DALI streams. Additional DALI controllers may be connected to the controller-side wireless module which will allow control of multiple DALI streams with multiple legacy DALI controllers. The present invention can work with legacy DALI controllers. When current DALI controllers, those which supports the special DALI commands, are used with a wireless gateway, each DALI controller can address multiple DALI streams.

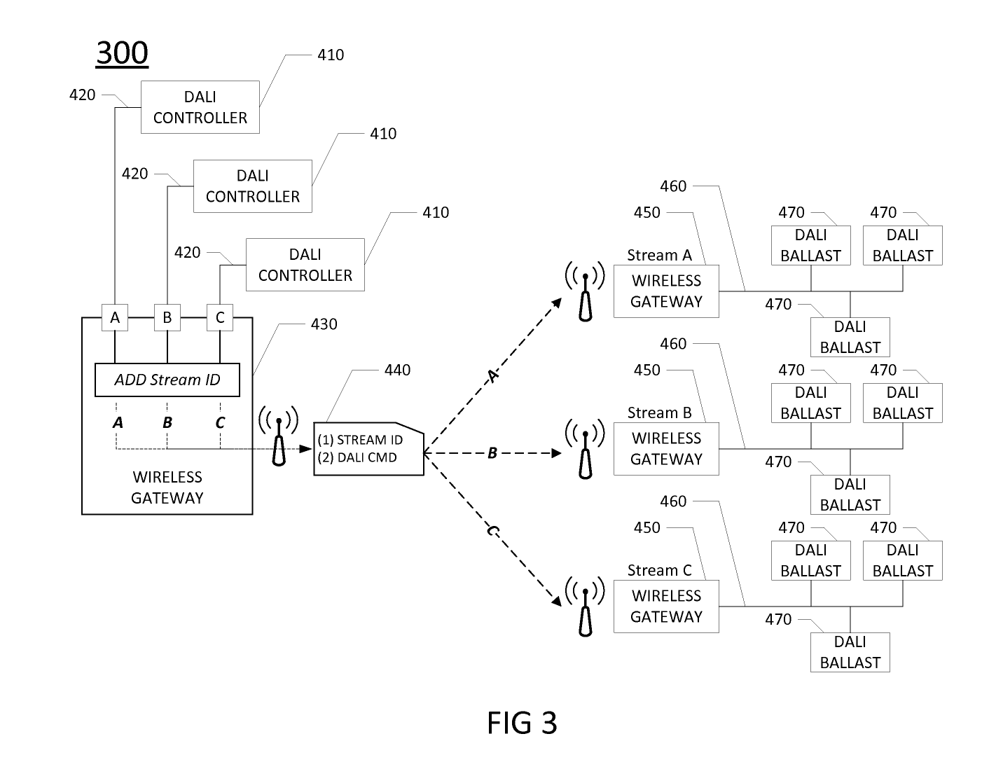

In FIG. 3 another preferred embodiment of an exemplary lighting control system 300 is depicted. FIG. 3 shows an additional topology where the controller wireless gateway supports multiple physical DALI ports. Each physical DALI port is able to support one or more logical DALI streams using the same strategy depicted in FIG. 2. Supporting multiple physical ports allows for greater usage of the bandwidth of the wireless gateway, allows multiple physical DALI controllers to be attached, and also allows DALI controllers who are unable to support the reserved DALI stream selection command to communicate on a single ZigBee PAN with multiple streams.

By issuing the special DALI command to select the logical stream, a DALI Controller can address number of DALI peripherals that is only limited by the practicality of the implementation and is no longer limited to the physical limitation of 64 per stream.

For legacy DALI Controllers which do not support the special DALI command, the logical DALI stream is associated to the port which the DALI Controller is connected to the controller side wireless module. Each legacy DALI Controller is still capable of addressing up to 64 DALI devices. For this scenario, the maximum number of uniquely controlled DALI devices is equal to 64X where X is the number of DALI Controllers.

On the controller side, one or more physical DALI inputs are provided each of which can support multiple logical streams using the special DALI command. In the case where a DALI controller does not utilize the special DALI commands to select a logical DALI stream, they can simply attach to any DALI port on the wireless module and communicate as usual and the wireless module will use the default DALI stream ID associated with each physical port. A DALI Controller capable of issuing the special DALI command and a DALI Controller not capable of specifying the special DALI command can be connected at the same time to the controller-side wireless gateway.

For ease of narrative the wireless communication protocol in this representative example will be the ZigBee communication protocol. Other wireless communication protocols may be utilized. FIG. 3 presents an embodiment of the present invention in which multiple DALI controllers control multiple DALI streams via a single wireless gateway comprised of a controller-side wireless module 430 and at least one ballast-side wireless module 450. Multiple DALI controllers 410 are individually connected via a first two wire data bus 420 (e.g. a twisted pair wire) to a controller-side wireless module 430. The wireless gateway is provisioned with multiple physical DALI ports on the controller-side wireless module 430. Each physical DALI port may be connected via first two wire data bus 420 to one DALI controller 410. The controller-side wireless module 430 communicates via a wireless communication protocol to ballast-side wireless modules 450.

Each ballast-side wireless module 450 is individually connected via a second separate two wire data bus 460 to at least one DALI ballast 470 (slave) which is connected to at least one lamp bank 480 (not depicted). A DC power supply, not shown, may be integrated with each DALI controller 410 or may be provided separately to each DALI controller 410. A separate DC power supply, also not shown, may be integrated with each ballast-side wireless module 450 or may be provided separately to each.

The controller-side wireless module 430 and the ballast-side wireless module 450 each comprise a set of software components that encode and decode the DALI protocol and handle data encapsulation over an intermediate wireless medium while maintaining a reference to the DALI stream from which the traffic originated and is destined to arrive and which provide for the seamless control of each lamp bank 480 by the appropriate DALI controller 410 even though the DALI controller 410 is not hard wired directly to DALI ballasts 470. It should be obvious to those skilled in the art that in other embodiments of the present invention that the DALI controllers 410 may be wired directly to additional ballasts provided each DALI controller 410 does not perceive more than 64 ballasts on a single stream.

Multiple logical DALI streams can be encapsulated over a single DALI interface by using a special DALI command which allows each DALI controller 410 to specify a stream number to the controller-side wireless module 430. The Controller Wireless Gateway is provisioned with multiple physical DALI ports on the controller-side wireless module 430. Each physical DALI port is able to support one or more logical DALI streams. When the special DALI command is received, the controller-side wireless module 430 will take all subsequent DALI commands received over the same physical interface to be associated with the specified DALI stream until the next time the DALI controller 410 changes the DALI stream by issuing another instance of the special DALI command.

The controller-side wireless module 430 translates the stream number specified by the appropriate DALI controller 410 to a stream ID parameter that is used to route the message within the wireless network to the appropriate DALI stream.

On the controller-side wireless module 430, multiple physical DALI inputs (e.g. DALI ports) are provided each of which can support multiple logical streams on the ballast-side wireless modules 450 using the special DALI commands. In the case where a DALI controller 410 does not support the special DALI commands to select a logical DALI stream, the DALI controller 410 can be attached to any open DALI port on the controller-side wireless module 430 and communicate via one of the ballast-side wireless modules 450 with the appropriate logical DALI stream. The Wireless Gateway will assign a single logical DALI stream on each physical input.

The controller-side wireless module 430 will use the port's pre-defined stream ID when the DALI Controller has not issue the special DALI command to specify the stream ID. As a representative example, referring to FIG. 3, the DALI Controller connected to controller-side wireless module port A may use the wireless gateway to send a command to a ballast on stream B or a ballast on stream C by use of a special command indicating that particular stream. So to control a ballast on stream B, the stream A DALI controller will send a special command stream ID for stream B. The commands from DALI controller A will continue to devices on stream B until DALI Controller A issues a command ID for either stream A or stream C. Prior to issuing commands to stream B or stream C, DALI controller A may control a device on stream A simply by issuing a command or it may precede the command with special command stream ID A. In this scenario a controller-side wireless module with multiple DALI ports is capable of supporting DALI Controllers which explicitly specifies the DALI stream ID using the special DALI command and DALI Controllers that do not issue the special DALI command.

The stream ID approach allows both synchronous and asynchronous DALI communication subject to the standard constraints of DALI. While a response is waiting to arrive from a command issued on one DALI stream, commands from alternate DALI streams can be processed.

This approach typically operates in a synchronous fashion just like standard DALI. This system also allows for asynchronous communication by allowing the controller side wireless module to also utilize a reserved DALI command to indicate a stream ID followed by the back frame back to the upstream DALI controller. This is less interoperable and therefore can be enabled or disabled by the DALI controller issuing a special DALI command to turn on or off asynchronous mode.

This approach typically operates in a synchronous fashion just like standard DALI. This system also allows for asynchronous communication by allowing the controller-side wireless module 430 to also utilize a special DALI command to indicate a stream ID followed by the back frame back to the appropriate upstream DALI controller 410. This is less interoperable and therefore can be enabled or disabled by the DALI controller 410 issuing a special DALI command to turn on or off asynchronous mode.

ZigBee Implementation

When the wireless gateway uses a ZigBee wireless protocol, each ZigBee cluster which encapsulates a DALI command is prepended with an additional numeric identifier. This numeric identifier indicates a ‘stream id’, or a unique identifier that allows the Wireless Gateway to route DALI commands and ensure they go to and come from the proper DALI stream on the external DALI Controllers 410 and DALI Control Devices 470.

Each ballast-side wireless module 450 utilizes an identifier switch allowing an installer to configure which DALI stream the module belongs to. The identifier switch may be either physical (i.e. a dipswitch, control pot, or the like) or logical (determined by software setting).

The controller-side wireless module 430 adds the DALI stream identifier to the ZigBee cluster associated with the physical port on which the DALI command was received or based on the DALI Controller 410 issuing the special DALI command to explicitly identify the stream ID. The Wireless Gateway routes the message based on this stream ID to only the ballast-side wireless modules which have been configured for that respective stream. Multiple ballast-side wireless modules may be configured to the same stream ID.

Each ballast-side wireless module only responds to DALI commands that contain a stream ID in the ZigBee cluster that match the configuration on the module. For messages destined for the given ballast-side wireless module, the ballast-side wireless module will pass the DALI command to the local physical DALI stream. Any responses from the command are routed back to the Controller utilizing the same DALI stream ID such that the DALI controller can properly return a message to the specified stream.

The stream ID contained in each ZigBee cluster is opaque outside of the Wireless Gateway to promote interoperability. DALI devices operate in their typical fashion with the Wireless Gateway handling the assignment and routing internally based on their configuration.

Each Wireless Gateway attached to a ZigBee Controller can also have a Controller ID specified. This allows multiple Controllers to exist on a single ZigBee PAN and adds additional numbers of possible DALI stream identifiers to the network. The wireless modules discover and self-configure to uniquely issue stream identifiers preventing ID conflicts without the need for configuration beyond the Controller ID on each Controller wireless module.

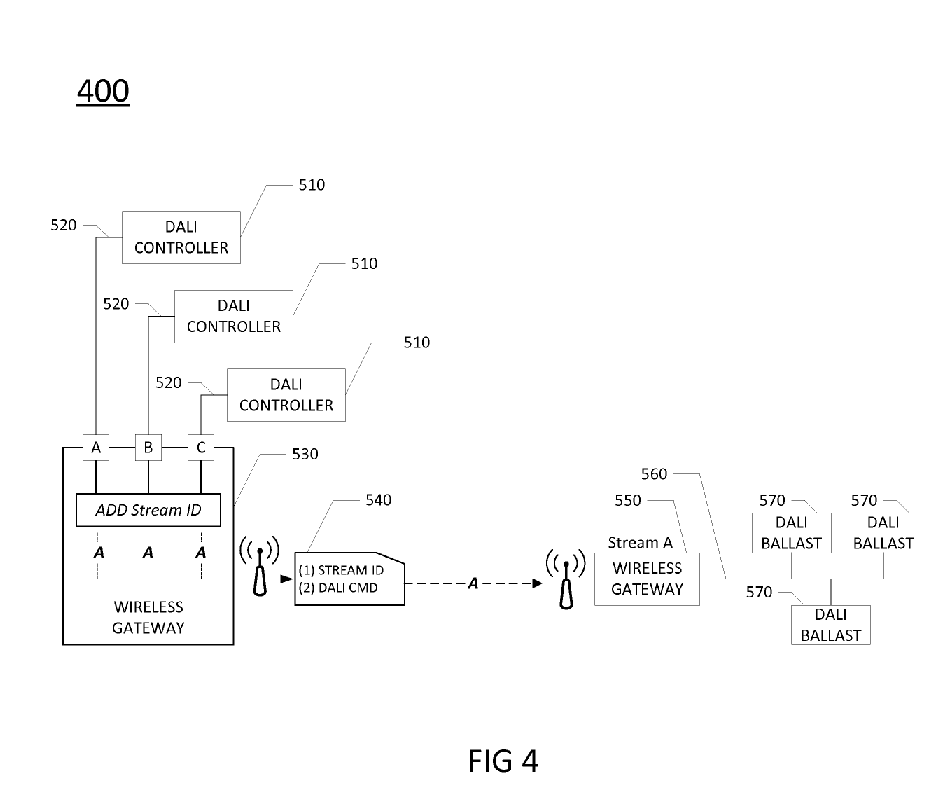

In certain limited circumstances, it may be desirable for multiple DALI controllers to operate ballasts on a single DALI stream via a wireless gateway. FIG. 4 presents a representative example of the present invention 400 wherein multiple DALI controllers 510 use a wireless gateway comprised of a controller-side wireless module 530 and a ballast-side wireless module 550 to control ballasts 570 on a single DALI stream. The DALI controllers are connected to the controller-side wireless module 530 via a first two-wire pair 520. The controller-side wireless module 530 communicates wirelessly with the ballast-side wireless module 550 which is connected by a second two-wire pair 560 to at least one ballast 570. Each ballast 570 is hardwired to a light (not depicted). A DC power supply, not shown, may be integrated with each DALI controller 510 or may be provided separately to each DALI controller 510. A separate DC power supply, also not shown, may be integrated with the ballast-side wireless module 550 or may be provided separately to each.

When issuing a command each DALI controller may issue a special DALI command to indicate the DALI controller's logical stream. This enables the DALI peripheral to which the command issues to direct the back frame to that particular DALI Controller.

The controller-side wireless module 530 and the ballast-side wireless module 550 each comprise a set of software components that encode and decode the DALI protocol and handle data encapsulation over an intermediate wireless medium while maintaining a reference to the DALI stream from which the traffic originated and is destined to arrive and which provide for the seamless control of each ballast 570 by the appropriate DALI controller 510 even though the DALI controller 510 is not hard wired directly to DALI ballasts 570.

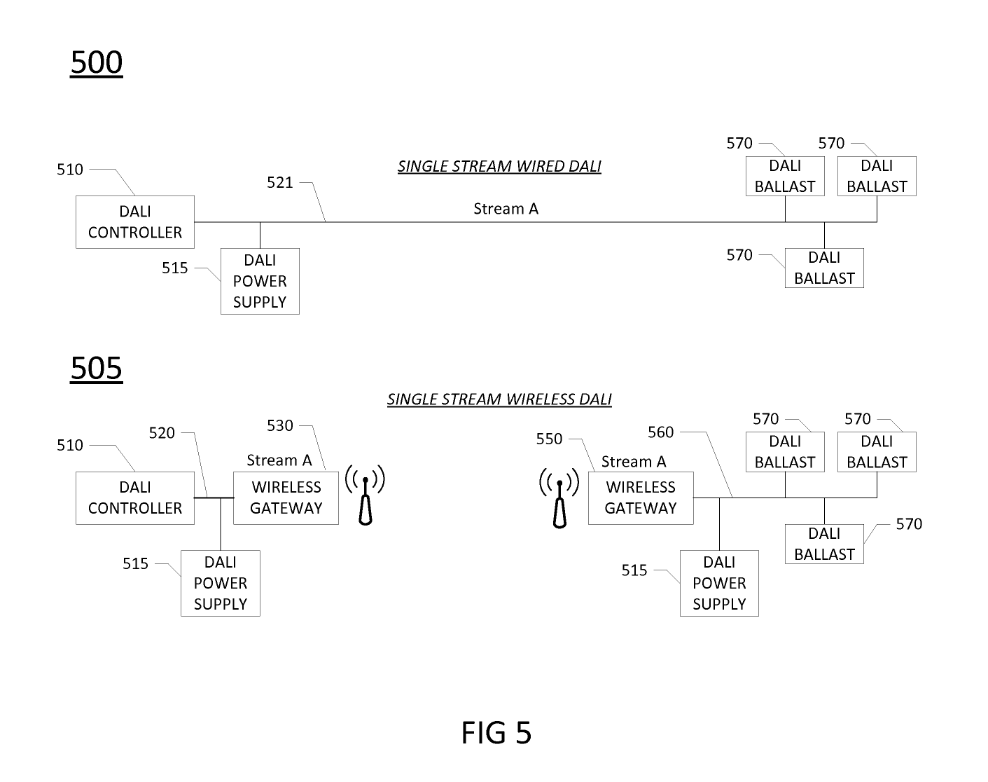

FIGS. 5, 6, and 7 provide representative examples of how hard wired DALI streams may be converted to wireless DALI streams. Referring to FIG. 5 and the representative example depicted therein, a single DALI stream 500 is depicted. The DALI stream 500 comprises a DALI controller 510 connected via a two wire data bus 521 to a DALI power supply 515 and DALI ballasts 570. In the representative example of FIG. 5, three DALI ballasts are depicted but as those skilled in the art are aware, the DALI stream could have up to 64 DALI ballasts connected to the stream.

DALI stream 505 comprises the same DALI controller 510 and DALI ballasts 570 as DALI stream 500. DALI controller 510 is connected to a DALI power supply 515 and to a controller-side wireless module 530 via a first two wire data bus 520. The controller-side wireless module 530 communicates via wireless protocol with a ballast-side wireless module 550. Together, the controller-side wireless module 530 and the ballast-side wireless module 550 comprise a wireless gateway. The ballast-side wireless module 550 is connected to the DALI ballasts 570 and to an additional DALI power supply 515 via a second two wire data bus 560.

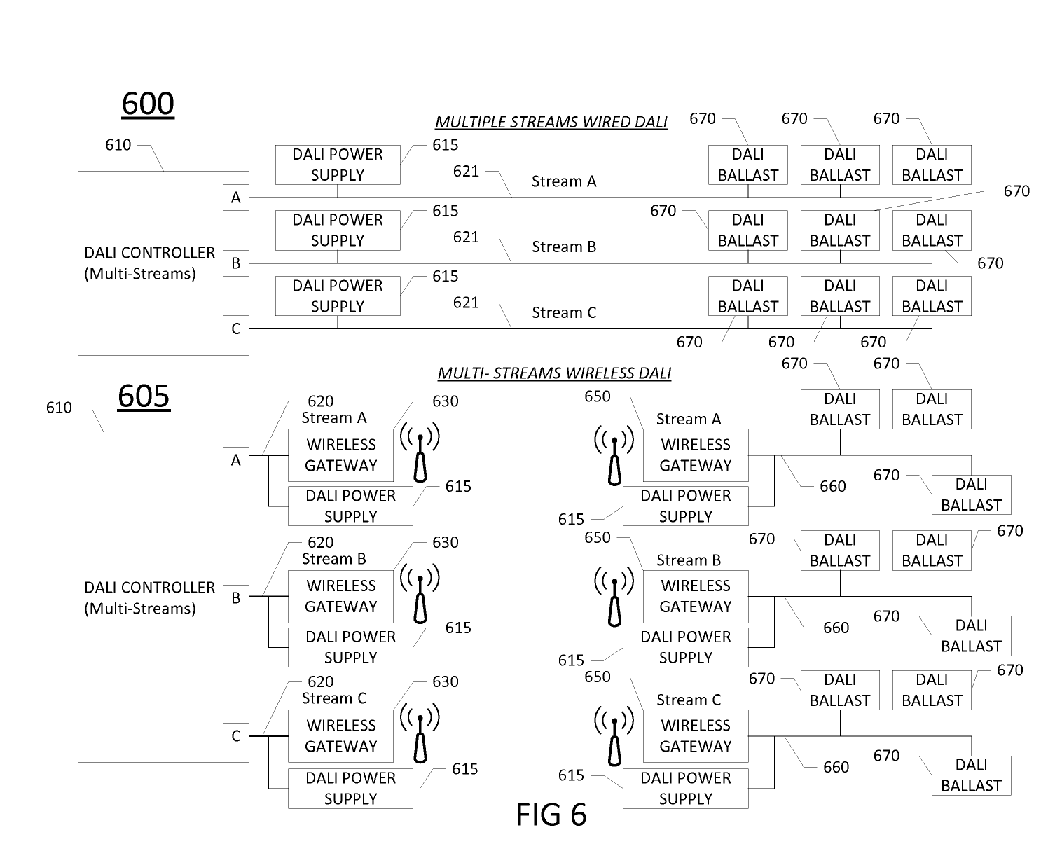

Referring to FIG. 6 and the representative example depicted therein, a network of DALI streams 600 is depicted. The DALI stream network 600 comprises a DALI controller 610 connected to multiple DALI streams. Each DALI stream comprises a two wire data buses 621, a DALI power supply 615 and DALI ballasts 670. In the representative example of FIG. 6, three DALI streams are depicted but as those skilled in the art are aware, the DALI controller 610 may be connected to multiple DALI streams where the limit on how many DALI streams is the number of DALI ports on the DALI controller 610.

DALI stream 605 comprises the same DALI controller 610 and DALI ballasts 670 as DALI stream 600. DALI controller 610 is connected to multiple DALI streams. Each DALI stream comprises a DALI power supply 615 and a controller-side wireless module 630 connected via a first two wire data bus 620. Each controller-side wireless module 630 communicates via wireless protocol with a ballast-side wireless module 650. Together, each controller-side wireless module 630 and ballast-side wireless module 650 comprise a wireless gateway. Each ballast-side wireless module 650 is connected to the DALI ballasts 670 and to an additional DALI power supply 615 via a second two wire data bus 660.

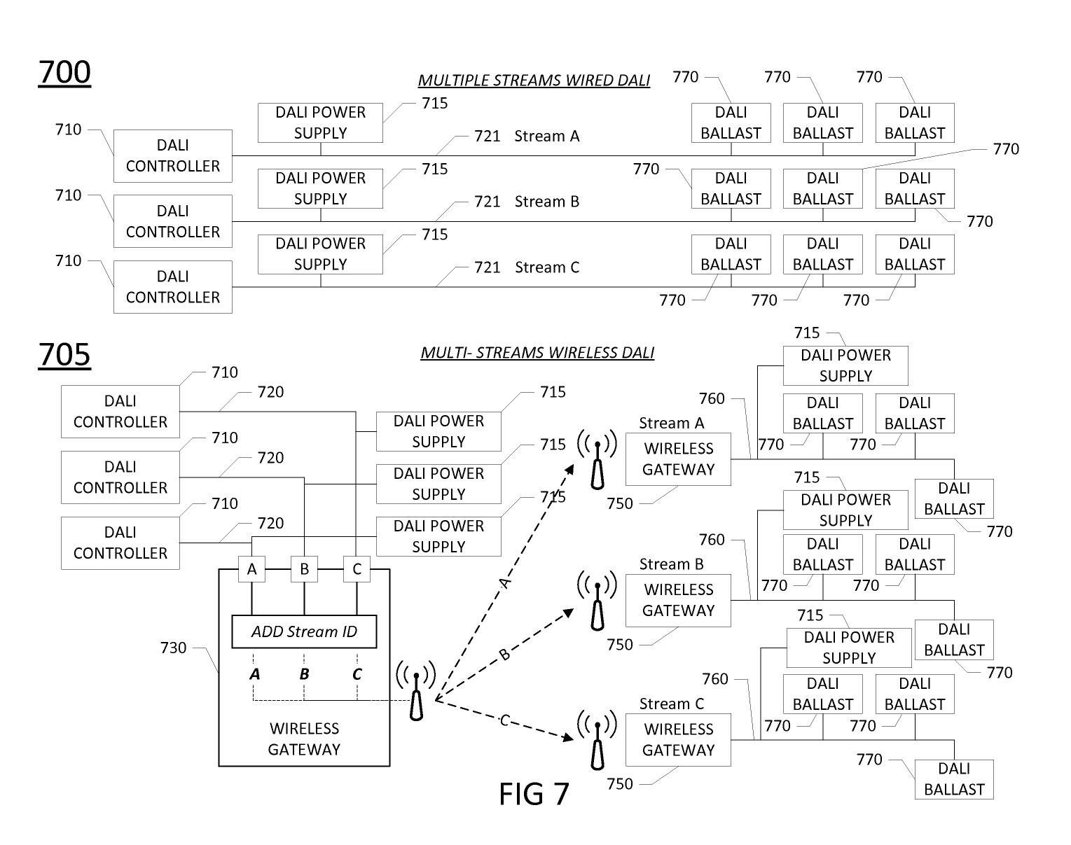

Referring to FIG. 7 and the representative example depicted therein, another network of DALI streams 700 is depicted. The DALI stream network 700 comprises multiple DALI controllers 710 each connected to a DALI stream. Each DALI stream comprises a two wire data buses 721, a DALI power supply 715 and DALI ballasts 770. In the representative example of FIG. 7, three DALI streams are depicted but as those skilled in the art are aware, there is no practical limit to the number of DALI streams that may be employed.

DALI stream network 705 comprises the same DALI controllers 710 and DALI ballasts 770 as DALI stream network 700. Several DALI controllers 710 each are connected to a DALI stream.

Each DALI stream comprises a DALI power supply 715 and a controller-side wireless module 730 connected via a first two wire data bus 720. The controller-side wireless module 730 communicates via wireless protocol with multiple ballast-side wireless modules 750. Together, the controller-side wireless module 730 and ballast-side wireless modules 750 comprise a wireless gateway. Each ballast-side wireless module 750 is connected to the DALI ballasts 770 and to an additional DALI power supply 715 via a second two wire data bus 760.

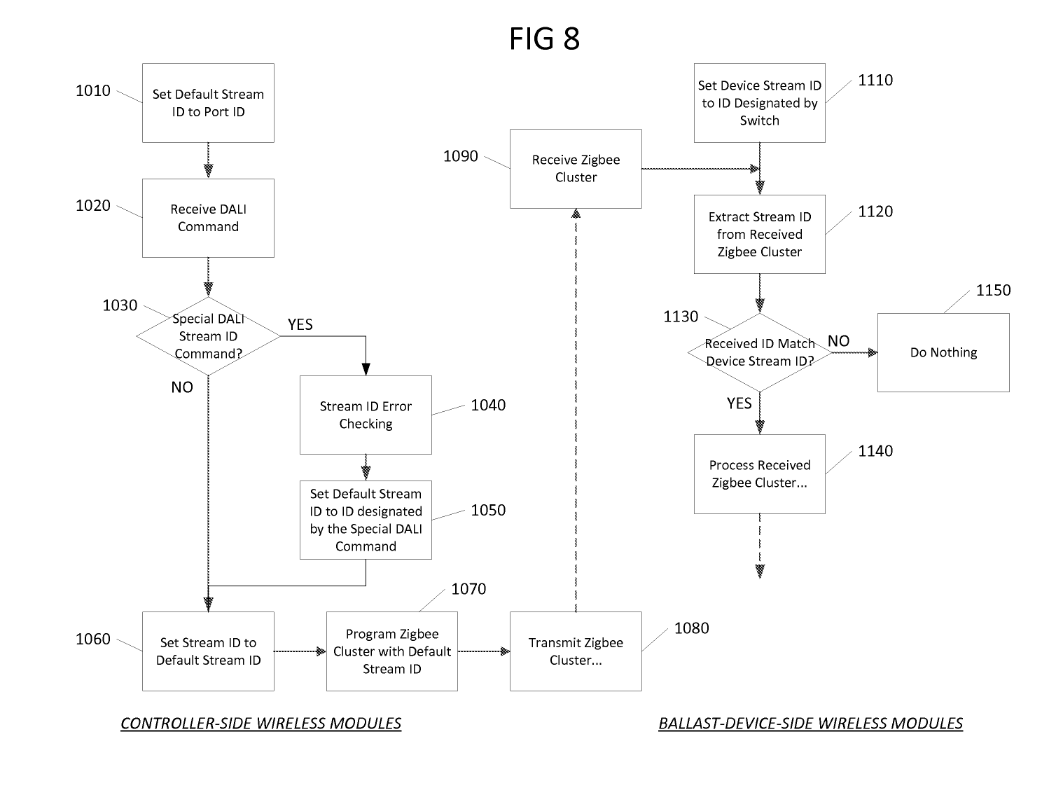

Referring to FIG. 8, a flow chart of the control logic for a method to control multiple DALI streams over a single DALI interface on a ZigBee personal area network is depicted. The logic depicted is enacted in a wireless gateway comprising at least one controller-side wireless module and at least one ballast-side wireless module. Each controller-side wireless module is hard wired via a two wire data bus to at least one DALI controller and each ballast-side wireless module is hard wired via a two wire data bus to at least one DALI ballast. In step 1010, a stream ID is assigned to each DALI stream. The default stream ID is set to the port ID for each DALI stream.

In step 1020, a controller-side wireless module receives a DALI command from a DALI controller.

In step 1030, the controller-side wireless module determines whether the DALI command contains a special DALI stream ID command. When issued, a special DALI stream ID command identifies the appropriate ballast-side DALI stream to which the command is intended. If a special DALI stream ID command is received proceed to step 1040. If a special DALI stream ID command is not received proceed directly to step 1060.

In step 1040, the controller-side wireless module checks the special DALI stream ID command to verify that the specified stream ID is valid. If no valid stream ID is received the associated commands will be ignored. If the stream ID is valid, proceed to step 1050.

In step 1050 the controller-side wireless module sets the default stream ID to the stream ID designated by the special DALI command. The controller-side wireless module will transmit communications to the ballast-side wireless module associated with that stream ID.

In step 1060, the current default stream ID is set to the stream ID associated with the received DALI command.

In step 1070, the DALI command is encapsulated and converted to a ZigBee cluster. The ZigBee cluster contains the stream ID.

In step 1080, the ZigBee cluster is transmitted to the ballast-side wireless modules.

In step 1090, the ZigBee cluster is received by the ballast-side wireless modules.

In step 1110, each ballast-side wireless module is assigned a stream ID. This assignment can be accomplished via physical means such as adjusting a dip switch, or it can be made via software.

In step 1120, each ballast-side wireless module extracts the stream ID from the received ZigBee cluster.

In step 1130, each ballast-side wireless module compares the extracted stream ID to its own stream ID. If the extracted stream ID matches its own stream ID, then the ballast-side wireless module is the appropriate module and the DALI ballast stream associated with that ballast-side wireless module is the appropriate DALI stream. Proceed to step 1140. If the extracted stream ID does not match its own stream ID, then proceed to step 1150.

In step 1140, the received ZigBee cluster is processed by the ballast-side wireless module and the DALI command is reaggregated. The DALI command is sent to the DALI ballasts and is acted upon by the appropriate DALI ballasts. Back frames, where appropriate, are transmitted back to the ballast-side wireless module. The ballast-side wireless module associates the stream ID with the back frame, creates a ZigBee cluster including the stream ID, and transmits the ZigBee cluster to the controller-side wireless module. The controller-side wireless module reaggregates the back frame and the back frame is sent to the original DALI controller.

In step 1150, the ballast-side wireless module determines that the DALI command is not meant for ballasts on its DALI stream and the DALI command is not processed.

Although several embodiments of the present invention, methods to use said, and its advantages have been described in detail, it should be understood that various changes, substitutions and alterations can be made herein without departing from the spirit and scope of the invention as defined by the appended claims. The various embodiments used to describe the principles of the present invention are by way of illustration only and should not be construed in any way to limit the scope of the invention. Those skilled in the art will understand that the principles of the present invention may be implemented in any suitably arranged lighting system. Those skilled in the art will also understand that the principles of the present invention may be implemented in any suitably arranged building control system. Examples of such building control systems include but aren't limited to energy minimization systems; heating, ventilation, and air conditioning (HVAC) systems, building security systems, and the like.

We claim:

1. A DALI compatible wireless lighting control system comprising:
at least one DALI controller;
a first two wire data bus;
a wireless gateway comprising a controller-side wireless module and at least one ballast-side wireless module;
at least one DALI compatible controlled device;
at least one second two wire data bus;
and at least one lamp bank.

2. The DALI compatible wireless lighting control system of claim 1 wherein the wireless gateway uses a wireless communication protocol.

3. The DALI compatible wireless lighting control system of claim 1 wherein the wireless communication protocol is ZigBee.

4. A DALI compatible wireless lighting control system comprising:
at least one DALI controller;
a first two wire data bus;
a wireless gateway comprising a multitude of controller-side wireless modules and at least one ballast-side wireless module;
at least one DALI compatible controlled device;
at least one second two wire data bus;
and at least one lamp bank.

5. The DALI compatible wireless lighting control system of claim 4 wherein the wireless gateway uses a wireless communication protocol.

6. The DALI compatible wireless lighting control system of claim 4 wherein the wireless communication protocol is ZigBee.

7. A DALI compatible wireless building control system comprising:
at least one DALI controller;
a first two wire data bus;
a wireless gateway comprising a controller-side wireless module and at least one ballast-side wireless module;
at least one DALI compatible controlled device;
at least one second two wire data bus;
and at least one of an HVAC system, building security system, and energy minimization system.

8. The DALI compatible wireless building control system of claim 7 wherein the wireless gateway uses a wireless communication protocol.

9. The DALI compatible wireless building control system of claim 8 wherein the wireless communication protocol is ZigBee.

10. A method of controlling multiple lights connected to one or more DALI streams via a wireless gateway comprising the steps of:
assigning a port ID on a controller-side wireless module;
assigning a device stream ID to a DALI stream on a ballast-side wireless module;
receiving a DALI command at the controller-side wireless module from a DALI controller;
setting the stream ID to the default stream ID;
creating a ZigBee cluster;
including the stream ID with the ZigBee cluster;
transmitting the ZigBee cluster from the controller-side wireless module to the ballast-side wireless module;
extracting the stream ID from the ZigBee cluster;
comparing the stream ID to the device stream ID;
and enacting the command on a ballast when the stream ID and device stream ID are identical.

11. The method of claim 10 further comprising the steps of
assigning a default stream ID to a port ID on a controller-side wireless module;
identifying whether the received DALI command contains a special DALI stream ID command;
when the received DALI command contains said special DALI stream ID command, checking the stream ID for validity and setting the default stream ID to the special DALI stream ID;
